(19) United States
(12) Patent Application Publication
(10) Pub. No.: US 2026/0187338 A1
(43) Pub. Date: Jul. 2, 2026

(54) SYSTEM AND METHOD FOR SEMANTIC PARSING OF DIGITAL DOCUMENTS USING VISUAL AND TEXTUAL FEATURES

(71) Applicant: Hong Kong Applied Science and Technology Research Institute Company Limited, Hong Kong (HK)

(72) Inventors: Chi Ting HON, Burnaby (CA); Qijun ZHU, Hong Kong (HK); Li XU, Hong Kong (HK); Yacheng LI, Hong Kong (HK); Likai PENG, Shenzhen (CN); Tao YU, Hong Kong (HK)

(21) Appl. No.: 19/004,507

(22) Filed: Dec. 30, 2024

(51) Int. Cl. G06F 40/106; G06F 40/205; G06V 30/414

(52) U.S. Cl. CPC G06F 40/106; G06F 40/205; G06V 30/414

(57) ABSTRACT

A system for semantic parsing of an input digital document using visual and textual features is provided. The system includes a user interface, a document layout classification module, a semantic recovery module, and a text structuring module. The user interface enables users to upload the input digital document. The document layout classification module processes the document to categorize its elements based on page images and textual data, outputting layout information with tags and locations. The semantic recovery module uses this layout information to derive content, including tables, lists, and charts, and generates a hierarchical structure. The text structuring module organizes tokens based on the layout tags, groups text into sections by topic relevance, and handles page boundaries, producing another hierarchical structure.

### TECHNICAL FIELD

The present invention relates to document parsing technologies; and in particularly to systems and methods for semantic parsing of digital documents using visual and textual features.

### BACKGROUND

Many face challenges in managing vast amounts of unstructured digital (i.e., PDF) documents, which complicate tasks like classification, data extraction, and information retrieval. PDF parsing offers a solution by efficiently organizing information, enhancing operational workflows, and enabling advanced natural language processing (NLP) tasks, such as information extraction and retrieval-augmented generation (RAG).

However, PDF parsing tools under the current state of the art have significant limitations. Most of these tools rely on machine learning (ML) models, which often result in inaccuracies when handling complex layouts or unconventional formats in the target documents. These tools also struggle to accurately process tables, lists, and charts, which reduce their contribution in fields where data extraction is really needed, such as finance, legal, and healthcare. Another drawback is the inability to recover the hierarchical structure of documents, a fundamental requirement for scenarios needing logically organized content. Without this capability, the output often lacks the contextual relationships essential for effective information retrieval and semantic understanding, reducing the usefulness of existing tools in handling more complex document processing tasks.

Therefore, there is a need for a digital document parsing system that recovers complex elements and hierarchical structures for better information retrieval.

### SUMMARY OF INVENTION

In accordance with a first aspect of the present invention, a system for semantic parsing of a digital document using visual and textual features is provided. The system includes a user interface, a document layout classification module, a semantic recovery module, and a text structuring module. The user interface is configured to allow user interaction for uploading (inputting) a digital document to the system. The document layout classification module electrically communicates with the user interface and receives the digital document from the user interface as input. The document layout classification module is configured to categorize document elements of the digital document based on page images and text metadata information and to output layout information with tags and locations. The semantic recovery module electrically communicates with the document layout classification module and is configured to derive information from the digital document, which may comprise one or more of tables, lists, charts, and combinations thereof, by using the layout information to capture document's content and generate a first human-readable hierarchical structure representation. The text structuring module electrically communicates with the document layout classification module and is configured to organize tokens of the digital document based on the tags of the layout information, cluster text into sections based on the substantive topic relevance, and deal with page boundaries, to generate a second human-readable hierarchical structure representation.

In accordance with a second aspect of the present invention, a method for semantic parsing of a digital document using visual and textual features is provided. The method includes steps as follows: providing a user interface to allow user interaction for uploading a digital document; receiving, by a document layout classification module, the digital document from the user interface as input; categorizing, by the document layout classification module, document elements of the digital document based on page images and text metadata information; outputting, by the document layout classification module, layout information with tags and locations; deriving, by a semantic recovery module, information from the digital document, which may comprise one or more of tables, lists, charts, and combinations thereof, by using the layout information to capture document's content, such that the semantic recovery module generates a first human-readable hierarchical structure representation; and organizing, by a text structuring module, tokens of the digital document based on the tags of the layout information, clustering text into sections based on the substantive topic relevance, and dealing with page boundaries, such that the text structuring module generates a second human-readable hierarchical structure representation.

### BRIEF DESCRIPTION OF DRAWINGS

Embodiments of the invention are described in more details hereinafter with reference to the drawings, in which:

FIG. 1 depicts a schematic architecture of a system for semantic parsing of a digital document using visual and textual features according to one embodiment of the present invention;

FIG. 2 depicts a schematic architecture of a document layout classification module according to one embodiment of the present invention;

FIG. 3 illustrates an exemplary result of layout information generated using a document layout classification module according to one embodiment of the present invention;

FIG. 4A and FIG. 4B are schematic diagrams illustrating transformation of plain text tables into a hierarchical tree structure using the table extraction model according to one embodiment of the present embodiment;

FIG. 5 demonstrates a list transformation flow based on linguistic features in list text using the list item structuring model according to one embodiment of the present invention;

FIG. 6A illustrates the types of lists that can be processed by the list item structuring model according to one embodiment of the present invention, including dense lists and sparse lists;

FIGS. 6B, 6C, and 6D are schematic diagrams illustrating the generation of hierarchical relationships of list items using the list item structuring model according to one embodiment of the present invention;

FIG. 7 demonstrates a chart to be processed by the chart analysis model to extract key-factor information according to one embodiment of the present invention;

FIG. 8 demonstrates a process flow for parsing and organizing text into cohesive lines through a two-branch process according to one embodiment of the present invention;

FIG. 9 illustrates an example of text lines structuring by the text-blocks structuring model according to one embodiment of the present embodiments;

FIG. 10A illustrates the process of topic-coherent binding using the text-blocks structuring model according to one embodiment of the present invention; and

FIG. 10B illustrates the process of continuation of text with identical semantic unit at boundary using the text-blocks structuring model according to one embodiment of the present invention.

### DETAILED DESCRIPTION OF THE INVENTION

In the following description, systems and methods for semantic parsing of digital documents using visual and textual features and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

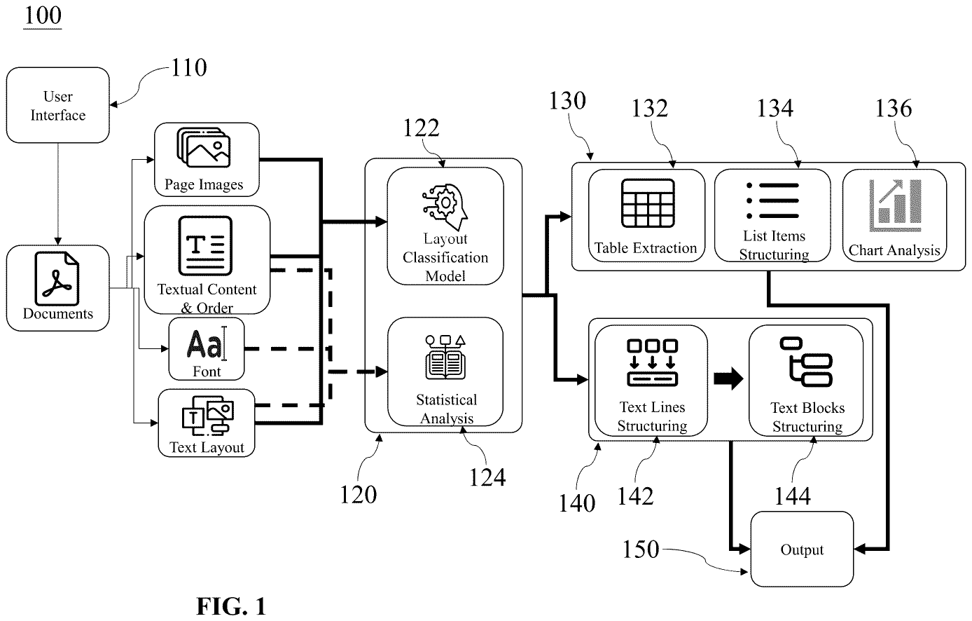

Referring to FIG. 1 for the following description. The system 100 is configured for digital document parsing by using a document layout classification stage, a semantic recovery stage, and a text structuring stage. Briefly, a selected digital document is input into the system 100 for processing, and a human-readable hierarchical structure representation is output, reflecting the content of the digital document. The system 100 includes a user interface 110, a document layout classification module 120, a semantic recovery module 130, a text structuring module 140, and an output module 150.

The user interface 110 is configured to allow user interaction for uploading an input digital documents. The user interface 110 enables users to upload (input) to the system 100 one or more input digital documents through either remote or local operations, providing flexibility in how input documents are received and processed. The system 100 supports both wired and wireless data communication uploads, such as through a network connection, and local uploads via direct file selection from a user's computing device. In one embodiment, the user interface 110 is further configured to receive an input digital document. In the present disclosure, a digital document refers to a PDF file in which the content, such as text, tables, and images, can be selected either by the user through a browser or by a machine reader. However, an ordinarily skilled person in the art can appreciate that digital documents of different types, and/or created by different software programmes can be readily adopted and applied upon by the present invention without undue experimentation or deviation from the spirit of the present invention.

The document layout classification module 120 is electrically communicates with the user interface 110 and receives the input digital document from the user interface 110 as input. The document layout classification module 120 addresses lack of layout information in the input digital document. The document layout classification module 120 identifies and tags elements, including paragraphs, sections, titles, and tables, thereby generating layout information using tags for the input digital document.

In one embodiment, the document layout classification module 120 takes page images and text metadata information of the input digital document as input. The document layout classification module 120 is configured to categorize document elements into various tags such as paragraphs, lists, sections, titles, captions, tables, figures, footers, and references and to output categorized words with tag and location.

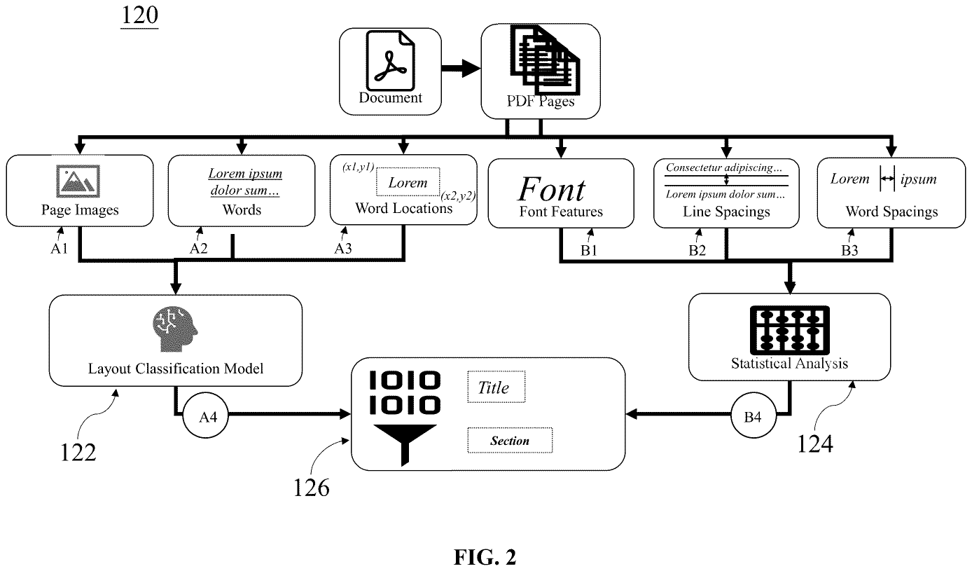

As shown in FIG. 2, the document layout classification module 120 includes a layout classification model 122 which is configured to generate a set of tags and a statistical analysis model 124 which is configured to enhance and correct the set of tags. The layout classification model 122 can generate the tags for the input digital document and then the statistical analysis model 124 applies statistical analysis to the input digital document, for extracting line and word spacing, as well as font attributes, for each word to correct the tags generated by the layout classification model 122. As a result, document elements are assigned tags by the layout classification model 122 and the statistical analysis model 124 collectively, including titles, sections, captions, paragraphs, lists, and footers as categorized words with tag and location. Accordingly, the layout classification model 122 and the statistical analysis model 124 process various inputs in cooperative fashion to generate layout information 126.

To further illustrate, the layout classification model 122 processes inputs A1, A2, and A3, which correspond to page images, words, and word locations, respectively. The input A2, representing the words, includes textual content and their order. The input A3, representing the locations, includes the text layout within the input digital document. The layout classification model 122 analyzes the inputs A1, A2, and A3 for identification and thus provides output A4, including classified tags such as paragraphs, lists, sections, titles, captions, tables, figures, footers, and references. The layout classification model 122 classifies the content of the input digital document into distinct element tags, facilitating downstream processes to construct the document's hierarchical structure. In one embodiment, the layout classification model 122 is built using a fine-tuned LayoutLMv3 model.

The statistical analysis model 124 complements the layout classification model 122 by addressing layout inconsistencies and improving tagging accuracy. The statistical analysis model 124 processes inputs B1, B2, and B3, which correspond to font features, line spacings, word spacings. By analyzing these attributes, the statistical analysis model 124 establishes a baseline for font properties, groups text hierarchically based on relative characteristics, and assigns structural tags such as titles, sections, captions, paragraphs, lists, and footers, for collecting these physical attributes as output B4. The statistical analysis model 124 is further configured to leverage contextual information to refine the tagging results. This enhancement mechanism can be applied to complex or unconventional document formats using the statistical analysis model 124.

For example, in one embodiment, if the layout classification model 122 identifies a table but cannot determine its boundaries due to overlapping text elements, the statistical analysis model 124 refines the table's position using text spacing and alignment information to refine the determination. Furthermore, in one embodiment, titles detected with ambiguous font properties in the output A4 gets clarified with the output B4's font baseline analysis. Through the integration, inconsistencies in the raw layout of the input digital document are resolved.

The output A4 is integrated with the output and B4 to generate the layout information 126. By combining the layout classification and statistical analysis, the document layout classification module 120 produces comprehensive layout information for the input digital document. This layout information 126 includes the attributes of document elements and their respective locations. The output layout information 126 from this stage provides elements in the input digital document with spatially mapped and tagged, acting a detailed representation of the document's structure.

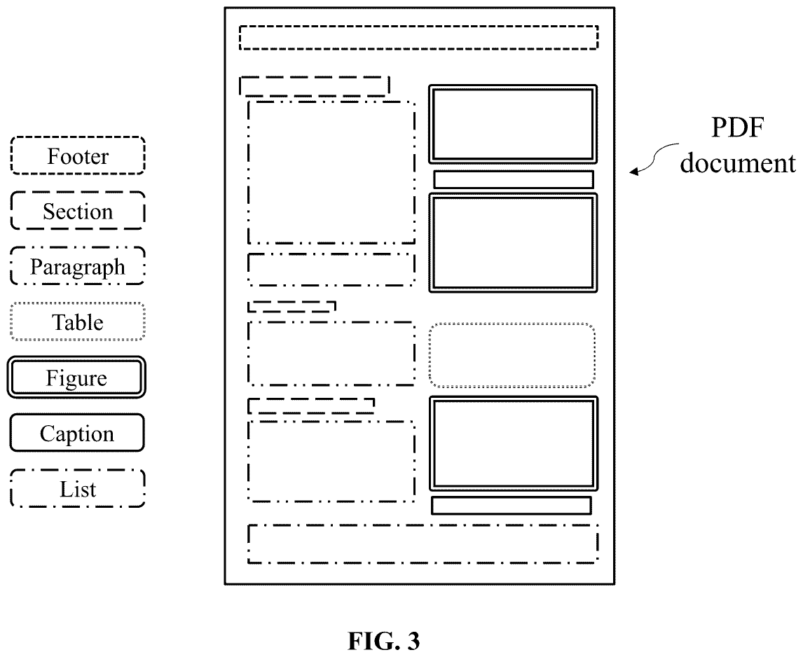

FIG. 3 illustrates an exemplary result of layout information generated using a document layout classification module according to one embodiment of the present invention. As shown, an input digital document is parsed through the document layout classification module as described above. After processing, the layout information 126 provides classified elements of the input digital document with associated tags, including footer, section, paragraph, table, figure, caption, and list. The generated layout information is both human-readable and machine-readable, enabling interpretation and utilization by the semantic recovery module 130 and the text structuring module 140. In this context, “machine-readable” refers to the ability of the semantic recovery module 130 and the text structuring module 140 to interpret the layout information and accordingly extract classified elements of the input digital document for subsequent processing.

Referring back to FIG. 1, the semantic recovery module 130 is configured to derive information from complex formats such as tables, lists, and charts based on the layout information 126. By leveraging categorized words with associated tags and locations from the layout information 126, the semantic recovery module 130 extracts information, at least including tables, lists, and charts, from the intricate structures. The output of the semantic recovery module 130 is a human-readable format, such as JSON, representation, capturing the input digital document content along with its hierarchical structure.

The semantic recovery module 130 includes a table extraction model 132, a list item structuring model 134, and a chart analysis model 136, which are served for parsing on different types of objects.

The table extraction model 132 is configured to transform plain text tables into a hierarchical tree structure (e.g., converting plain list text into structured text). In one embodiment, the table extraction model 132 employs a Camelot-PDF table extraction library to recognize tabular data within the text and layout. Specifically, the table extraction model 132 analyzes the designated area using layout and visual cues to identify tabular structures. Following the analysis, the table extraction model 132 parses the identified table content and generates a structured JSON file as output, providing an organized representation of the tabular data. In this regard, the layout information 126 supplies categorized tags and locations that guide the table extraction model 132 in identifying and interpreting the table boundaries and structures within the input digital document.

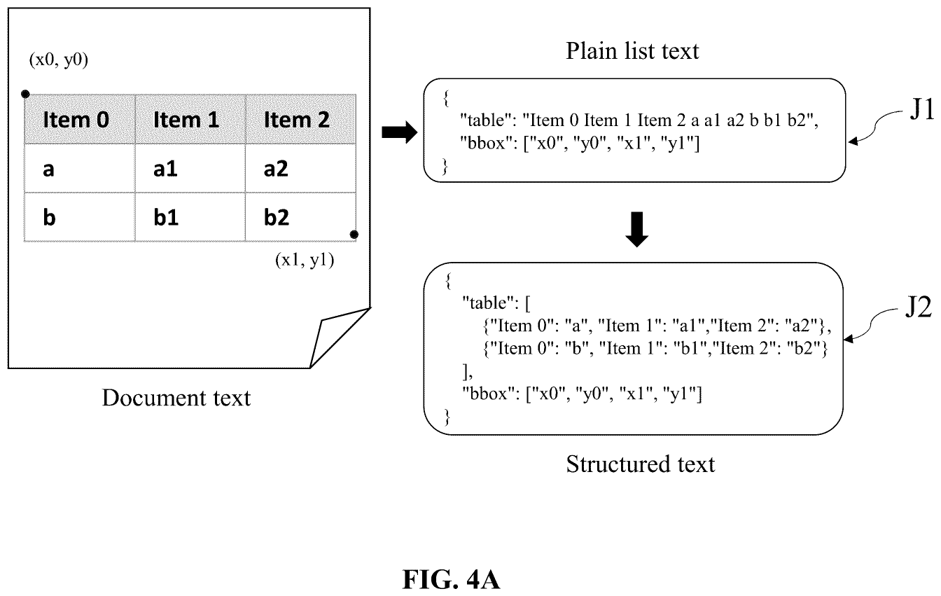

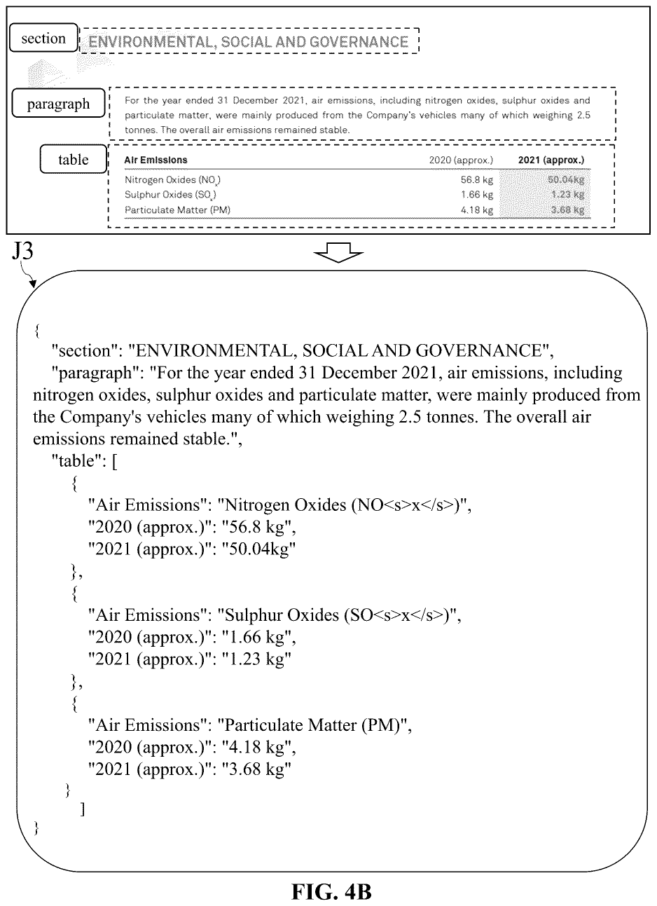

FIG. 4A and FIG. 4B are schematic diagrams illustrating transformation of plain text tables into a hierarchical tree structure using the table extraction model 132 according to one embodiment of the present embodiment. In FIG. 4A, the layout information 126 supplies categorized tags and locations, allowing for the extraction of the original document text containing tables from the input digital document and the generation of a JSON output referred to as “Plain list text” as depicted in block J1. Subsequently, the table extraction model 132 processes this output to generate a JSON output referred to as “Structured text,” as illustrated in block J2. In FIG. 4B, the positions of section, paragraph, and table are tagged, and the table extraction model 132 extracts their content and organizes it into a hierarchical tree structure, outputting it as a JSON file, as illustrated in block J3.

Referring again to FIG. 1, the list item structuring model 134 is configured to parse plain ordered list text and convert it into a hierarchical tree structure. With combination in utilizing the layout information 126, the list item structuring model 134 identifies elements within the input digital document that are likely or definitively parts of a list for parsing.

In one embodiment, the list item structuring model 134 employs a heuristic algorithm configured to identify numeral patterns using regular expressions. The heuristic algorithm leverages linguistic features within the input digital document, such as numeral patterns, to analyze both obscure and explicit ordered list layouts, enabling identification of hierarchical structures. The heuristic algorithm determines the transformation flow of the list based on the linguistic features, where the first identified numeral corresponds to the first-order item, and subsequent numerals indicate nested hierarchical levels. Furthermore, in one embodiment, the list item structuring model 134 is capable of processing unordered lists, enhancing its applicability to diverse document formats.

After the parsing process, the list item structuring model 134 generates a structured JSON file to represent the hierarchical relationships of the list items for the input digital document. The list item structuring model 134 supports various numeral formats, including alphabetic numerals (case-sensitive), Roman numerals (case-sensitive), and Arabic numerals, providing comprehensive parsing of ordered lists.

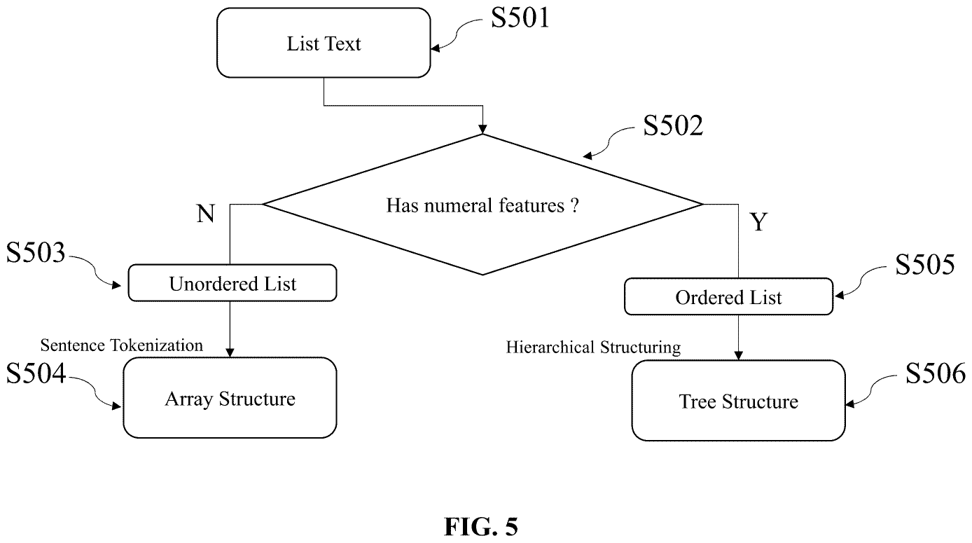

FIG. 5 demonstrates a list transformation flow based on linguistic features in list text using the list item structuring model 134 according to one embodiment of the present invention. The illustration provides how the list item structuring model 134 guides the transformation process based on linguistic features. Starting with the input list text (step S501), the list item structuring model 134 evaluates whether the list text contains numeral features (step S502). If no numeral features are detected, the list text is determined as an unordered list (step S503), then undergoing sentence tokenization to generate an array structure (step S504). Conversely, if numeral features are identified, the list text is classified as an ordered list (step S505) and then it is processed through hierarchical structuring to produce a tree structure (step S506) that captures the hierarchical relationships within the list text. Linguistic features, as highlighted in the diagram, play a critical role in determining the transformation pathway, ensuring precise structuring of both explicit and obscure list layouts.

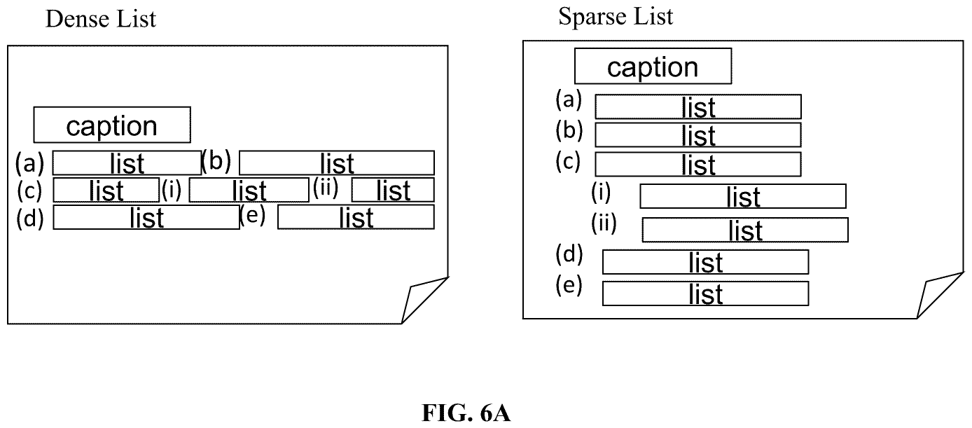

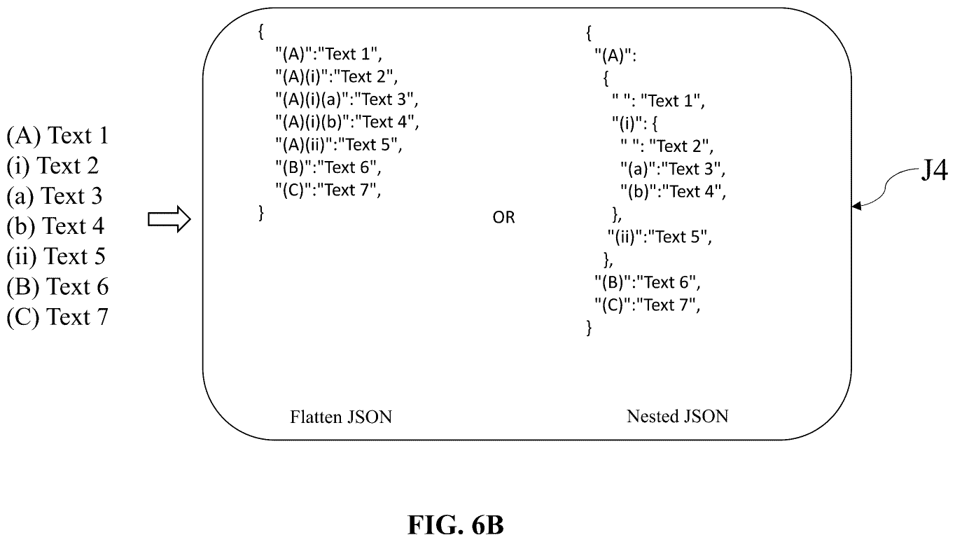

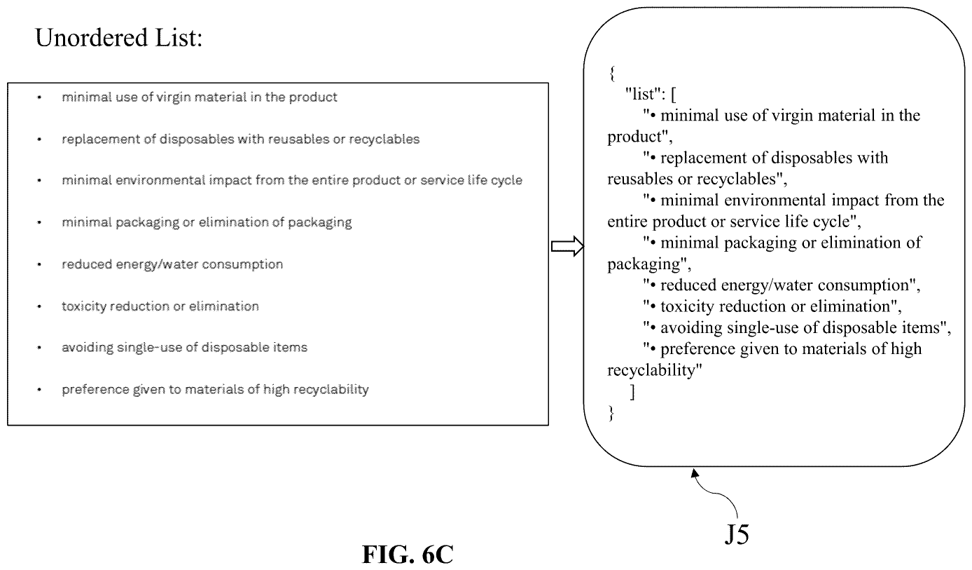

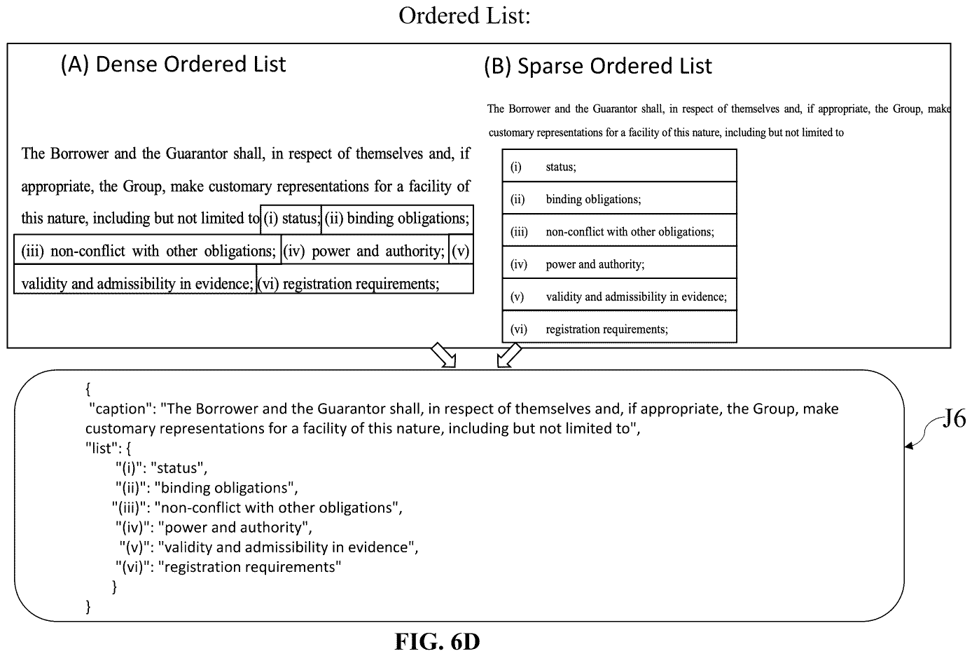

FIG. 6A illustrates the types of lists that can be processed by the list item structuring model 134 according to one embodiment of the present invention, including dense lists and sparse lists. FIGS. 6B, 6C, and 6D are schematic diagrams illustrating the generation of hierarchical relationships of list items using the list item structuring model 134 according to one embodiment of the present invention. In FIG. 6B, the hierarchical relationships of list items are converted into JSON format, as shown in block J4. In FIG. 6C, an unordered list is converted into JSON format, as shown in block J5. In FIG. 6D, an ordered list is converted into JSON format, as shown in block J6.

Referring back to FIG. 1, the chart analysis model 136 is configured to extract key-factor data from charts within the input digital document. By leveraging the layout information 126, the chart analysis model 136 identifies chart elements and their spatial arrangement within the input digital document, processing extraction and providing representation of chart data as a textual summary. In one embodiment, the chart analysis model 136 employs a large vision-language models (LVLM) method, which processes visual elements for charts, to transform key-factor details into a structured, textual format.

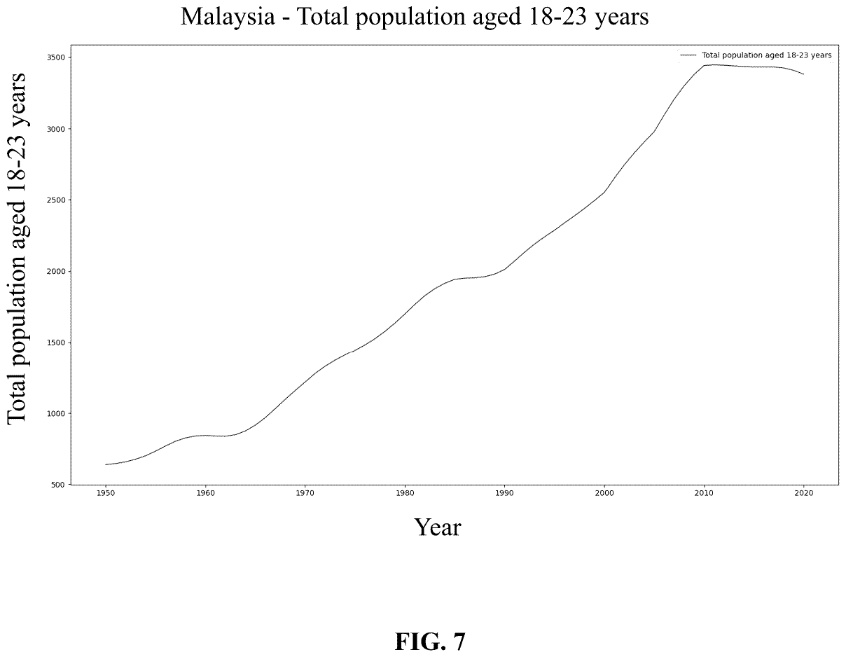

For example, referring to FIG. 7, the chart analysis model 136 is capable of parsing a line chart to extract key-factor information. The chart analysis model 136 identifies and lists the main theme of the line chart, as well as break down key observations and details under categories such as trend observation and key points. According to the line chart of FIG. 7, the chart analysis model 136 parses it and outputs as follows:

The image represents a line graph titled “Malaysia-Total population aged 18-23 years.” This graph tracks the population trends of individuals aged 18 to 23 years over time, specifically from the year 1950 to 2020.

### (1) Trend Observation:

Starting from the year 1950, the population started at a value slightly above 500.
The graph shows a gradual increase over the years, with the population steadily rising.
By the year 1970, the population had reached approximately 1000.
A significant increase can be observed by the year 1980, where the population crosses the 1500 mark.
As we progress through the 1980s and into the 1990s, the rate of increase accelerates, surpassing the 2500 mark by the year 2000.
The graph continues to rise sharply in the subsequent years.
By 2010, the population crosses the 3000 mark and reaches a value just below 3500 by 2020.

### (2) Key Points:

The initial increase in the 1950s and 1960s is moderate, reflecting a steady rise in the youth population.
A more rapid growth is observed in the 1980s, which suggests a significant demographic change or socio-economic factors influencing the youth population.
The marked rise in the 2000s indicates a possible surge in birth rates or improvements in healthcare and living conditions, contributing to a notable increase.

Referring back to FIG. 1, the text structuring module 140 is configured to reconstruct the hierarchical structure of the input digital document by applying a series of text structuring rules. The text structuring rules are based on categorized words, with corresponding the tags and the locations derived from the layout information 126. For example, the layout information 126 tags the locations of text content, and the text structuring module 140 is directed to extract the text accordingly, aligning it with the tags. The text structuring module 140 organizes tokens based on element tags, clustering text into sections based on topic relevance, and dealing with page boundaries. Additionally, the text structuring module 140 segments paragraphs into sentences by utilizing linguistic characteristics and grammatical principles. The final output of the text structuring module 140 is a human-readable format (e.g., JSON), which represents the content of the input digital document along with its hierarchical structure.

The text structuring module 140 includes a text-lines structuring model 142 and a text-blocks structuring model 144, which are served for parsing different types of objects.

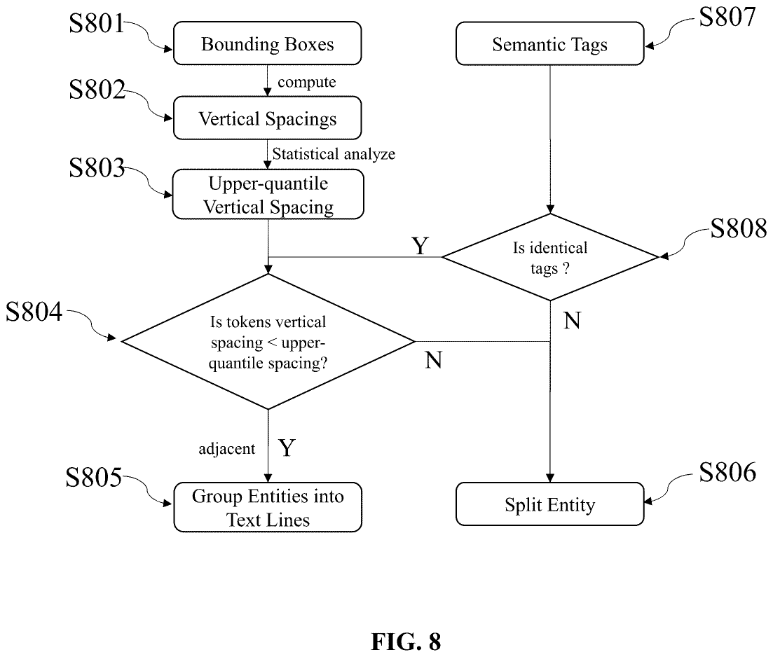

The text-lines structuring model 142 is configured to utilize the layout information 126 to parse and organize text into cohesive lines through a two-branch process, as shown in FIG. 8, in which the first branch is layout-based grouping and the second branch is semantic tag-based grouping. Both branches rely on layout information 126 to guide the grouping or splitting of tokens based on their visual proximity or semantic similarity. Herein, the term “token” refers to a discrete unit of text extracted from the document during the parsing process. It might be a word, punctuation mark, number, or any other meaningful segment of text identified for the purpose of structuring or analyzing the content. Tokens are the smallest building blocks used for organizing and processing the text based on either visual proximity (spatial arrangement) or semantic relationships.

In the first branch, bounding boxes are used to compute vertical spacings, as shown in blocks S801 and S802. The vertical spacings are then statistically analyzed to determine the upper-quantile vertical spacing, as indicated in block S803. A determination stage is performed (block S804). Tokens with vertical spacing less than the upper-quantile threshold are grouped into the same text line (block S805). If the vertical spacing is greater the upper-quantile threshold, the tokens are split (block S806).

The second branch evaluates semantic tags. Tokens with identical tags are further checked for vertical spacing, as shown in blocks S807 and S808. If both conditions are met, tokens with identical tags are grouped into the same text line (blocks S804 and S805). Otherwise, the tokens are split (block S806). Furthermore, if tokens have different semantic tags, they are treated as distinct entities and split accordingly (block S806). The second branch relies on the semantic relationships between tokens, such that elements with similar meaning, even if not visually adjacent, are grouped together if their vertical spacing complies with the set threshold.

Referring again to FIG. 1, the text-blocks structuring model 144 is configured to organize and group text elements into coherent blocks based on a set of criteria. The text-blocks structuring model 144 operates with two main principles: (a) topic-coherent binding; and (b) Continuation of text with identical semantic units at boundary.

Regarding (a) topic-coherent binding, the text-blocks structuring model 144 keeps all non-section text elements grouped together when they convey a coherent topic. This grouping is based on two conditions: (1) the text elements must be consecutive, and (2) they must be non-section elements. After token classification and grouping, different text elements are bound together to form a unified message. Accordingly, a “one section per text block” rule further performs that all non-section text elements are clustered, while sections are treated as separate, defining boundaries for text blocks.

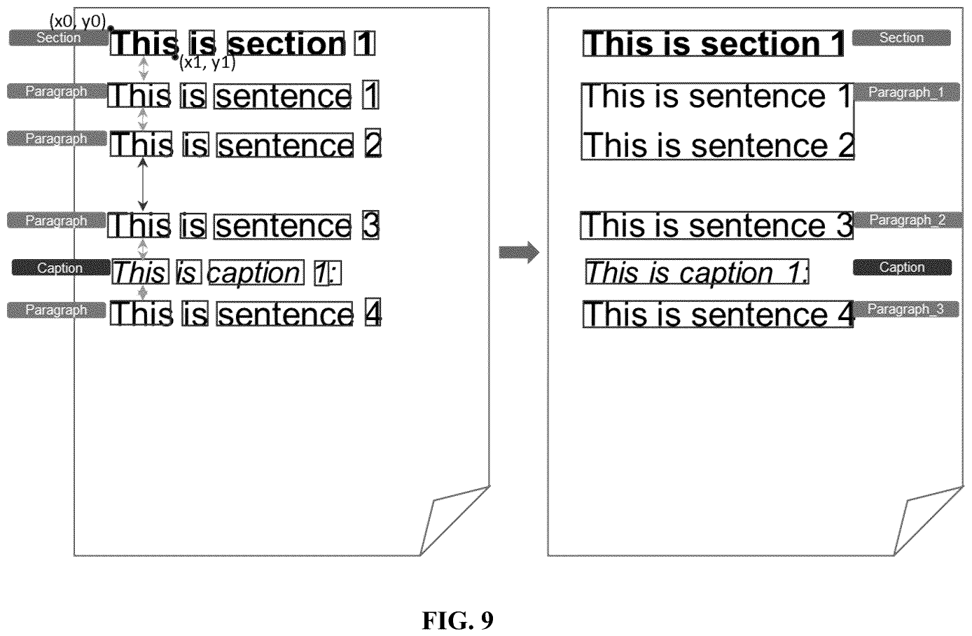

For example, FIG. 9 illustrates an example of text lines structuring by the text-blocks structuring model 144 according to one embodiment of the present embodiments. On the left side, raw text elements with various tags, such as “Section,” “Paragraph,” and “Caption,” are disorganized and include visual misalignments. Through the text-blocks structuring model 144, as shown on the right side, these elements are grouped and aligned into hierarchical information, making it human-readable easily.

Regarding (b) continuation of text with identical semantic units at boundary, the text-blocks structuring model 144 addresses issues of page boundaries. Content that spans across multiple pages, such as a paragraph continuing from one page to the next, might be incomplete at the boundary. In such cases, the text-blocks structuring model 144 checks for four conditions: (I) the text must be consecutive; (II) it must be non-section; (III) it must have the same semantic tag; and (IV) it must occur at the page boundary. If these conditions are met, the text across the page boundary is concatenated by the text-blocks structuring model 144 to form a single text string, completing the content and ensuring the logical flow of information.

In one embodiment, the text-blocks structuring model 144 is capable of discarding footers, which are considered irrelevant or redundant information in documents. By removing repetitive headers, footers, and page numbers, the text-blocks structuring model 144 results in more consistent entity assembling at the page boundary.

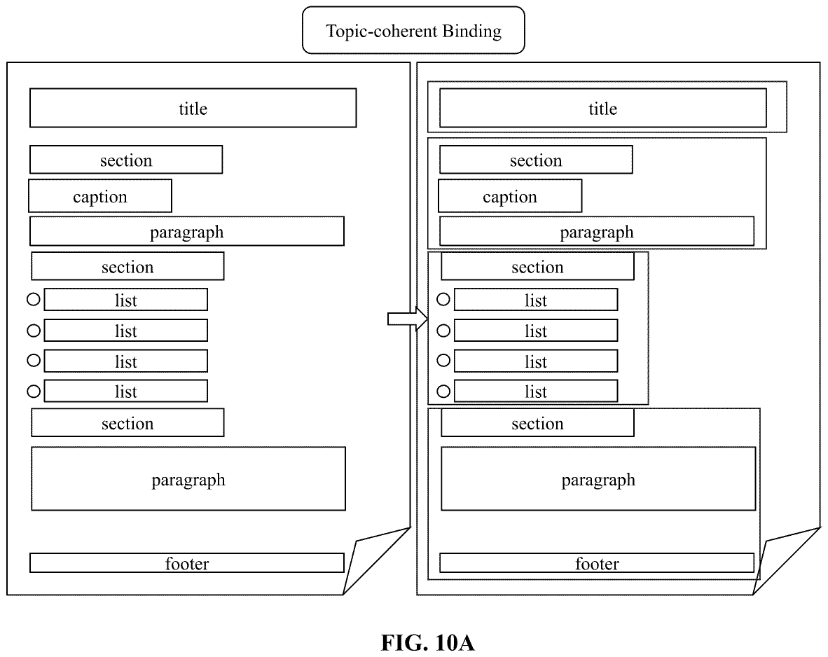

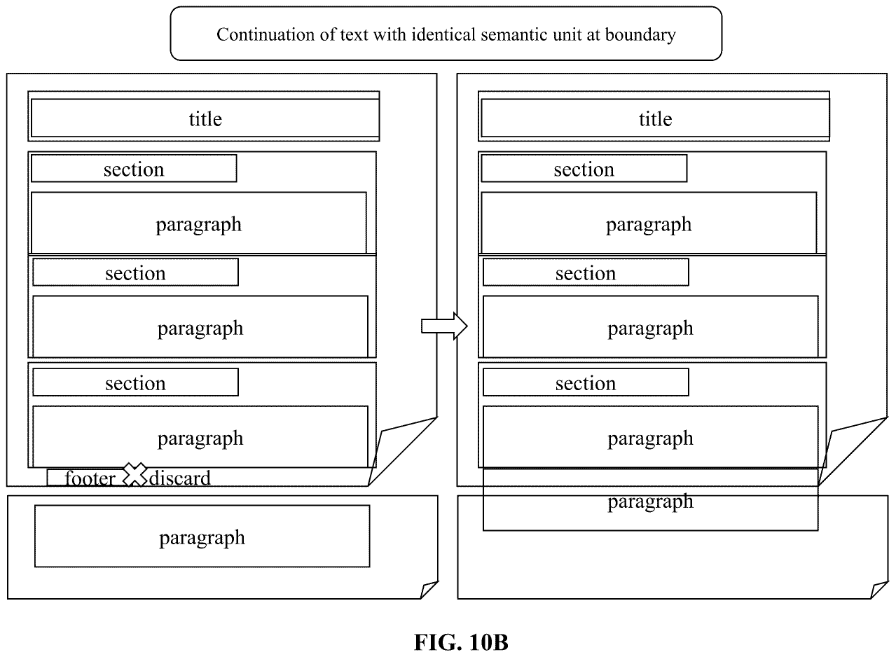

FIG. 10A illustrates the process of topic-coherent binding using the text-blocks structuring model 144 according to one embodiment of the present invention. The left side shows the ungrouped content before processing, and the right side demonstrates the content after grouping based on different tags. After token classification and grouping, various text elements are organized to form topic-coherent messages.

FIG. 10B illustrates the process of continuation of text with identical semantic unit at boundary using the text-blocks structuring model 144 according to one embodiment of the present invention. The left side shows the text before processing, and the right side demonstrates how the text is combined and continued across boundaries. Due to page boundaries, a document is split across multiple pages, resulting in incomplete content at the page boundary. Paragraphs conveying the same topic may be split across pages. Accordingly, text elements that share the same content (except sections or titles) are concatenated into a single text string to complete the content. Moreover, the irrelevant or redundant information in documents is discarded, such as footers.

Referring back to FIG. 1, the output module 150 is electrically communicates with the semantic recovery module 130 and the text structuring module 140 and is configured to generate and provide a parsed output of the input digital document in a user-friendly format. After processing the input digital document through parsing, the output module 150 delivers the resulting data in an easily accessible form, such as digital format or JSON format as afore-mentioned. Furthermore, the output module 150 provides detailed information about the contents of the input digital document, including whether the document contains tables, lists, or charts. This allows users to not only access the parsed text but also get an overview of the document's structure and elements.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for semantic parsing of an input digital document using visual and textual features, comprising:
a user interface configured to allow user interaction for uploading the input digital document;
a document layout classification module electrically communicating with the user interface and receiving the input digital document from the user interface as input, wherein the document layout classification module is configured to categorize document elements of the input digital document based on page images and text metadata information of the input digital document and to output layout information with tags and locations;
a semantic recovery module electrically communicating with the document layout classification module and configured to derive information from the input digital document, comprising one or more tables, lists, charts, and combinations thereof, by using the layout information to capture document's content and generate a first human-readable hierarchical structure representation; and
a text structuring module electrically communicating with the document layout classification module and configured to organize tokens of the input digital document based on the tags of the layout information, cluster text into sections based on substantive topic relevance, and deal with page boundaries, to generates a second human-readable hierarchical structure representation.

2. The system according to claim 1, wherein the tags made by the document layout classification module comprises paragraphs, lists, sections, titles, captions, tables, figures, footers, references, locations thereof, or combinations thereof.

3. The system according to claim 1, wherein the document layout classification module comprises:
a layout classification model configured to generate a set of the tags; and
a statistical analysis model configured to enhance and correct the set of tags.

4. The system according to claim 3, wherein the layout classification model takes page images, words, and word locations of the input digital document as input and outputs classified tags, and wherein the statistical analysis model takes font features, line spacings, and word spacings of the input digital document as input, and the statistical analysis model establishes a baseline for font properties, groups text hierarchically based on relative characteristics, and assigns structural tags, collecting these physical attributes as output.

5. The system according to claim 1, wherein the semantic recovery module comprises:
a table extraction model configured to transform plain text tables into a hierarchical tree structure, wherein the table extraction model employs a Camelot-PDF table extraction library to recognize tabular data within text and layout of the input digital document and analyzes a designated area based on the layout information using layout and visual cues to identify tabular structures, and further to parse identified table content.

6. The system according to claim 1, wherein the semantic recovery module comprises:
a list item structuring model configured to parse plain ordered list text and convert it into a hierarchical tree structure, wherein the list item structuring model employs a heuristic algorithm configured to identify numeral patterns and determine transformation flow of a list based on linguistic features, and wherein a first identified numeral corresponds to a first-order item, and subsequent numerals indicate nested hierarchical levels, so as to represent a hierarchical relationships of list items for the input digital document.

7. The system according to claim 1, wherein the semantic recovery module comprises:
a chart analysis model configured to extract key-factor data from charts within the input digital document, wherein the chart analysis model identifies chart elements and their spatial arrangement within the input digital document based on the layout information, processing extraction and providing representation of chart data as a textual summary.

8. The system according to claim 1, wherein the text structuring module comprises:
a text-lines structuring model configured to utilize the layout information to parse and organize text of the input digital document into cohesive lines using layout-based grouping and semantic tag-based grouping.

9. The system according to claim 1, wherein the text structuring module comprises:
a text-blocks structuring model configured to organize and group text elements of the input digital document into coherent blocks based on the layout information, wherein the text-blocks structuring model keeps all non-section text elements grouped together when they convey a coherent topic and comply with two conditions: the first condition is that the text elements must be consecutive, and the second condition is that the text elements must be non-section elements.

10. The system according to claim 9, wherein the text-blocks structuring model is further configured to concatenate text of the input digital document across page boundaries to form a single text string, provided that the text complies with the following conditions: the text must be consecutive, non-section, share the same semantic tag, and occur at the page boundary.

11. The system according to claim 10, wherein the text-blocks structuring model discards footers, resulting in consistent entity assembling for the text at the page boundary.

12. The system according to claim 1, further comprising:
an output module electrically communicating with the semantic recovery module and the text structuring module and configured to generate and provide a parsed output of the input digital document in a user-friendly format, containing whether input digital document contains tables, lists, or charts.

13. A method for semantic parsing of an input digital document using visual and textual features, comprising:
providing a user interface to allow user interaction for uploading the input digital document;
receiving, by a document layout classification module, the input digital document from the user interface as input;
categorizing, by the document layout classification module, document elements of the input digital document based on page images and text metadata information of the input digital document;
outputting, by the document layout classification module, layout information with tags and locations;
deriving, by a semantic recovery module, information from the input digital document, comprising one or more tables, lists, charts, and combinations thereof, by using the layout information to capture document's content, such that the semantic recovery module generates a first human-readable hierarchical structure representation; and
organizing, by a text structuring module, tokens of the input digital document based on the tags of the layout information, clustering text into sections based on substantive topic relevance, and dealing with page boundaries, such that the text structuring module generates a second human-readable hierarchical structure representation.

14. The method according to claim 13, further comprising:
generating, by a layout classification model, a set of the tags; and
enhancing and correcting, by a statistical analysis model, the set of tags, wherein the layout classification model takes page images, words, and word locations of the input digital document as input and outputs classified tags, and wherein the statistical analysis model takes font features, line spacings, and word spacings of the input digital document as input, and the statistical analysis model establishes a baseline for font properties, groups text hierarchically based on relative characteristics, and assigns structural tags, collecting these physical attributes as output.

15. The method according to claim 13, further comprising:
transforming, by a table extraction model, plain text tables into a hierarchical tree structure, wherein the table extraction model employs a Camelot-PDF table extraction library to recognize tabular data within text and layout of the input digital document and analyzes a designated area based on the layout information using layout and visual cues to identify tabular structures, and further to parse identified table content.

16. The method according to claim 13, further comprising:
parsing plain ordered list text and converting it into a hierarchical tree structure by a list item structuring model, wherein the list item structuring model employs a heuristic algorithm configured to identify numeral patterns and determine transformation flow of a list based on linguistic features, and wherein a first identified numeral corresponds to a first-order item, and subsequent numerals indicate nested hierarchical levels, so as to represent a hierarchical relationships of list items for the input digital document.

17. The method according to claim 13, further comprising:
extracting, by a chart analysis model, key-factor data from charts within the input digital document, wherein the chart analysis model identifies chart elements and their spatial arrangement within the input digital document based on the layout information, processing extraction and providing representation of chart data as a textual summary.

18. The method according to claim 13, further comprising:
utilizing, by a text-lines structuring model, the layout information to parse and organize text of the input digital document into cohesive lines using layout-based grouping and semantic tag-based grouping.

19. The method according to claim 13, further comprising:
organizing and grouping, by a text-blocks structuring model, text elements of the input digital document into coherent blocks based on the layout information, wherein the text-blocks structuring model keeps all non-section text elements grouped together when they convey a coherent topic and comply with two conditions: the first condition is that the text elements must be consecutive, and the second condition is that the text elements must be non-section elements.

20. The method according to claim 19, further comprising:
concatenating, by the text-blocks structuring model, text of the input digital document across page boundaries to form a single text string, provided that the text complies with the following conditions: the text must be consecutive, non-section, share the same semantic tag, and occur at the page boundary, and wherein the text-blocks structuring model discards footers, resulting in consistent entity assembling for the text at the page boundary.
